(19) United States
(12) Patent Application Publication
(10) Pub. No.: US 2008/0180317 A1
(43) Pub. Date: Jul. 31, 2008

(54) System for locating the position of an object

(76) Inventor: Keith Bushfield, Calgary (CA)

Correspondence Address: MILLER THOMPSON, LLP, Scotia Plaza, 40 King Street West, Suite 5800, TORONTO, ON, M5H 3S1, omitted

(21) Appl. No.: 11/698,152

(22) Filed: Jan. 26, 2007

(30) Foreign Application Priority Data
Jan. 26, 2007 (CA) 2,534,045

(51) Int. Cl. A63B 57/00; G01S 5/14; H04B 7/185

(52) U.S. Cl. 342/357.06; 473/407

(57) ABSTRACT

This invention relates to a system for locating the position of an object, and in particular relates to a system for a golf course used in locating the position of a golf ball which system includes full motion video and sound capabilities

### FIELD OF INVENTION

This invention relates to a system for locating the position of an object, and in particular relates to a system for a golf course used in locating the position of a golf ball which system includes full motion video and sound capabilities

### BACKGROUND TO THE INVENTION

Numerous positioning systems exist in the prior art. Many of these systems include Global Positioning Systems (GPS) for locating the position of objects. Such systems include locating the position of boats in the sea, automobiles, as well as the location of golf balls on the course.

The system which relate to a positioning system for golf courses include those in U.S. Pat. No. 6,470,242 which discloses a player position determining and course management system for a golf course having a plurality of roving units for use by players in playing the course. Each roving unit includes a central processing unit (CPU) including a data processor for executing various tasks ranging from fastest-execution of a task to slowest execution of a task on a schedule of priorities of task completion, a real-time means for controlling the processor to give the tasks priority ranging from fastest execution of a task with highest priority to slowest execution of a task with lowest priority, and a means for precisely timing functions of the system including modulating means utilizing a common digital modulation technique for digitally modulating data transmitted to and from all of the roving units. Each of the roving units include a monitor for displaying the golf course including each of the holes with its tee box, fairway, green, cup and hazards, as well as the position of the roving unit on the course in real time. Additionally, the system includes a course management base station for transmitting and receiving information to the roving units and a monitor for displaying the location of each roving unit on the golf course in real time.

Another golf ball locator system is shown in U.S. Pat. No. 6,634,959 which teaches a golf ball locator system including a golf ball including an electromagnetic signal transmitter; at least two electromagnetic signal receivers configured to receive an electromagnetic signal transmitted by the golf ball; and a processor coupled to the receivers and configured to receive signals from the receivers, to determine a location of the golf ball using triangulation calculations, and to output at least one signal indicating the location of the golf ball in relation to a two-dimensional area including the location of the golf ball.

Yet another system is shown in U.S. Pat. No. 6,908,404 which relates to a positioning system for determining the position of a golf ball. The golf ball positioning system includes a golf ball haying a first transmitter positioned therein for transmitting a position signal. The system further includes a detection unit having a first processor, a first receiver and a display. The first receiver and display are both connected to the first processor. The position signal is transmitted by the transmitter and is received by the first receiver and processed by the first processor. Upon processing the position signal, directional instructions are generated for display on the display and provide aid to the user in locating the position of the golf ball.

### BRIEF DESCRIPTION OF DRAWINGS

FIG. 1 is a representative drawing of the system for locating an object on a golf course.

FIG. 2 is a perspective view of the monitor.

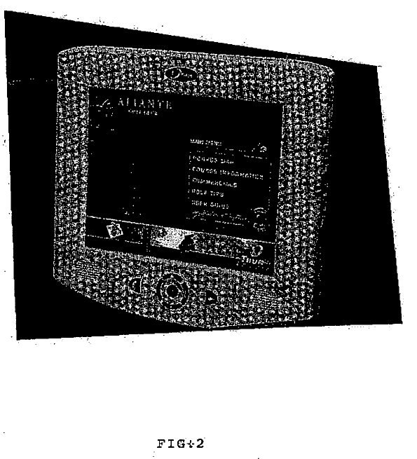

FIG. 3 is a top plan view of the monitor housing.

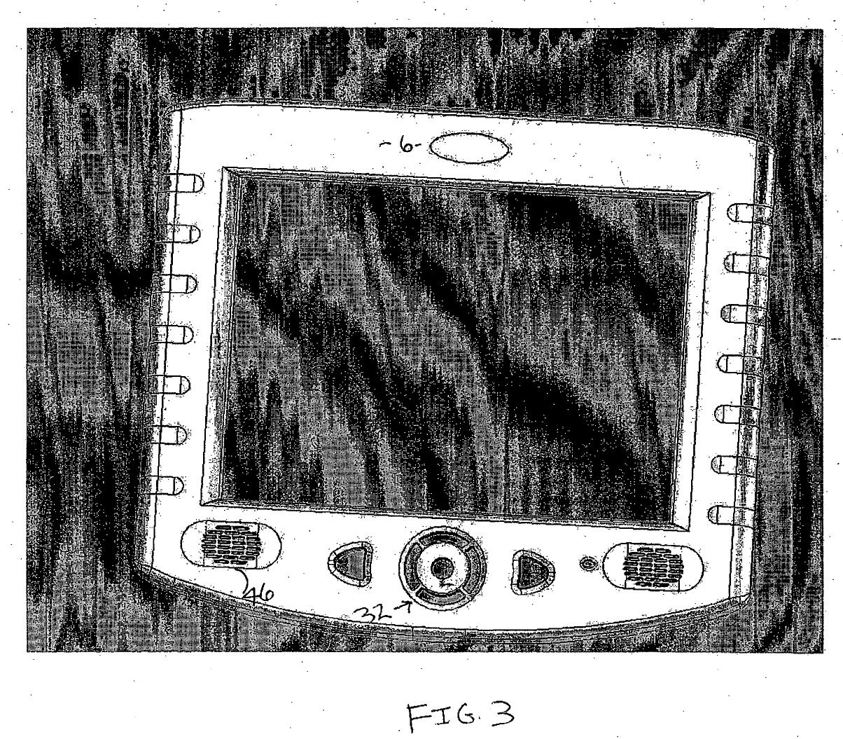

FIG. 4 is a panel insert for the monitor display.

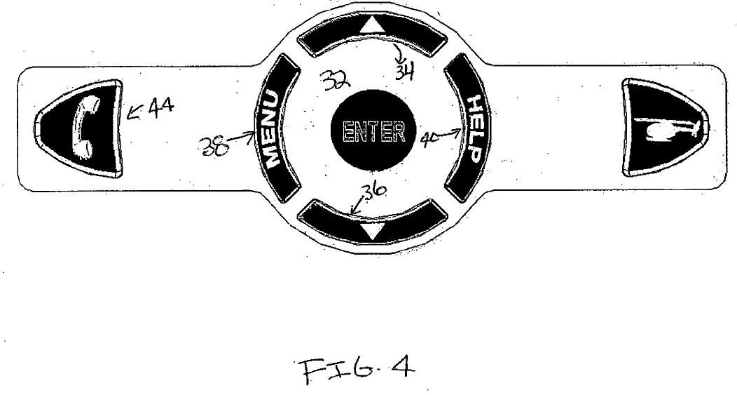

### BEST MODE FOR CARRYING OUT THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

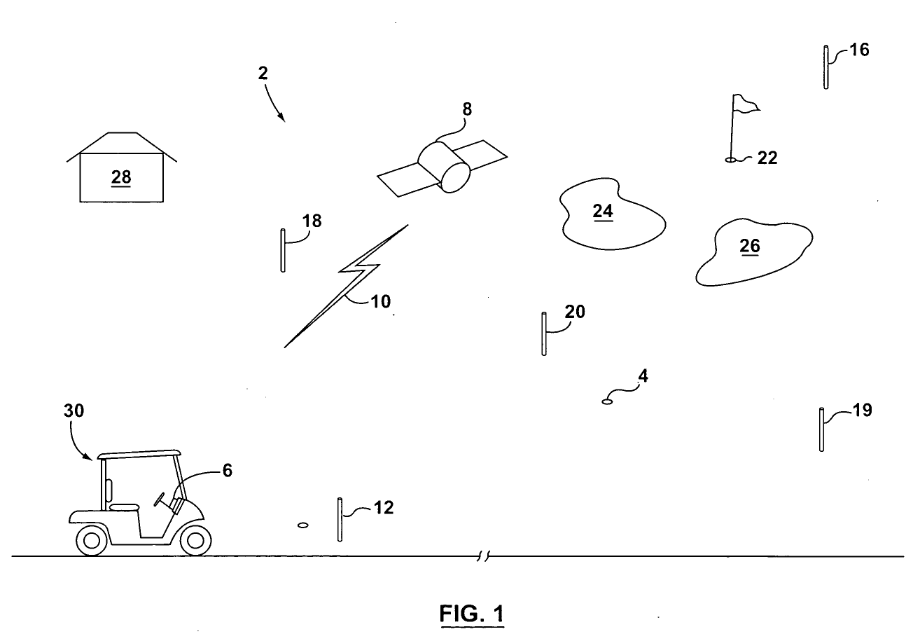

FIG. 1 is a representative drawing of the system for locating a golf ball 4 on a golf course having a golf cart 30, pin 32, sandtraps 24 and 26.

The system 2 includes a display monitor 6 which communicates by means of a signal 10 with a GPS 8.

The system also includes locating means 12, 14, 16, 18, 20 which comprise of a communicating pole that is generally inserted into the corners of a hole on a golf course. These poles 12, 14, 16, 18 are generally located at the corners of a particular hole. There is another pole 20 which is generally located equidistant from the other communicating poles 12, 14, 16, 18; so as to provide a plurality of triangulation communicating devices which will be more fully particularized below.

The GPS system 8 is utilized to locate the position of the golf ball 4 in association with the triangulating devices previously mentioned.

In order to set up the system an aerial view of each of the holes on the golf course are taken and stored in a computer. More particularly a helicopter (not shown) can be used to digitally store a three dimensional image of each of the holes on a golf course and stored in a storage device such as a computer or memory chip.

The display 6 includes an activating device 32 which can be activated by pushing a number of buttons to be described. For example, the button 38 may be pushed to include a pop up menu which can include such entries as course map, golf course information, commercials relating to golf products, golf tips or user guide. More particularly the screen on the display 6 will show a three dimensional flyby image of any of the holes selected. Generally speaking the hole number that the golfer is located will be displayed on the screen. The three dimensional image flyby shows full motion video images and sound. This full motion video is superior to existing devices which generally consist of still images or two dimensional layouts. If the course info is selected information is displayed on the screen again in full motion video format. Commercials can also appear by selecting the appropriate menu which consists of full video and sound. If the golf tip entry is selected a vocal pro can appear on the video screen again in full motion video and sound format making the product much more visually appealing to look at and listen verses still pictures.

A user guide will also include selected user guide information. All of the information referred to above can be stored in a computer chip in the display 6.

The display 6 can also include speaker 46.

A phone button 44 is also shown which can be configured to connect to the pro club, beer carts or field marshall in full two way communications. More particularly the full two way communication comprises of a two way full duplex system which means that both individuals can speak at the same time rather than by means of walkie talkie. One example of such signal communication is by way of radio frequency means. Any authorized frequency can be utilized.

The activating device 32 includes up and down menu buttons 34 and 36 as well as appropriate help button 40. Also, the activating device includes a helicopter button 42 to activate the full video three dimensional flyover of the holes.

Other activating devices can be utilized such as touch screen or the like.

The system including a plurality of triangulating devices as previously described. For example, if the ball 4 is best located between triangulating devices 12, 14, and 20 and these devices will triangulate the position of the ball 4 and will communicate the position to the display 6 in association with the GPS system 8 within an accuracy of 12 inches, thus making it superior to existing systems.

### Description of One Embodiment

### Graphical User Interface

we create all our own GUI screen, all of the video and graphical files are build using Photoshop, Aftereffects, Maya, the entire golf course is modeled in a virtual reality window allowing us to manipulate the camera angles, details, and flow of the system.
   Course map, yardage cards, and course information
These items again are custom built using off the shelf software. We model the entire course including the fairways, greens, golf carts, sand traps etc.

### 3D Flyovers

### Pre-production:

we shoot live helicopter flyover videos for reference.
these live flyover videos are cleaned-up and spliced into 18 reference videos
we obtain detailed blue prints and schematics of the golf course layout.
we write the voice over script for each hole

### Production:

from the above reference material, we build detailed CG (computer graphics) models of all 18 holes
from these CG models we render 3D Flyovers videos of all 18 holes

### Post-Production:

we composite the 3D Flyover with background music, a voice over and other graphical elements to create the final 3D Flyover of each hole.

### Commercials

some commercial content is produced sole in-house, from storyboarding to final production
some commercial content is already produced and we convert them to a usable format for playback on our system.

### Golf Tips

we shot live golf tip videos using a golf pro

### Tour Caddie Info:

### System Concept:

We mount a LCD screen system into a golf cart by attaching it to the steering column or the dash.

As the player drives up to hole number one, or whichever hole they choose to begin on, our GPS/triangulation system tells the tour caddie device (the “player”) which hole they are on. The on board proprietary chip board accesses the appropriate information for the hole the cart is on. The golfer is displayed a 3-Dimensional view of the Yardage card and the distances to the green and any hazards such as sand traps, water etc. After a short period of time (adjustable by the course) the device runs the full motion video and sound flyover of the hole in question. While this flyover is being played the golfer will hear audio from the device explaining how to play the hole. (example: avoid the water to the right, etc.) Upon completion of the flyover the machine will also access the commercial file associated with the hole. (This commercial feature is not mandatory; it will be dictated based on course wants) This commercial is also either a full motion video commercial or a static (non-moving) image. If there is a commercial component to the system, upon competition the device will revert back to the initial Yardage card info.

As the golfer proceeds down the hole towards the green, the GPS/Triangulation technology will update the distances to the green, pin, hazards, etc.

At any time the golfer can access the menu system simply by pressing the menu button on the front of the player. This will allow the golfer to access to course information, course map, hole sponsors, golf tips, user guide.

The golfer can access these items once in the menu screen by simply using the up down arrows to navigate between the desired categories, thus pressing enter to go into that category.

At any time the golfer may press the flyover button (helicopter button) located on the case to view the full motion video flyover of the hole. Also by entering the course map file on the menu screen they can access any hole or flyover they wish, not simply the hole the cart is on at that time.

The golfer can also press the “phone” button to call the club house, beverage cart, field marshals, or any one else on the course that the course operators wish to enable. This full duplex voice communications is fully digital, utilizing a RF frequency.

As the golfer proceeds around the course the GPS/triangulation system updates the hole to which they are playing and the information associated with that hole.

Other advantages include:
1. the flyover is narrated by a course pro detailing information such as yardage and suggested tactics to help enhance each golfers experience.
2. The distance to pin telementary delivers to each golfer yardage information with superior accuracy.
3. The system allows the course operator to monitor cart locations, usage time on course as well as increase speed of play and golfer enjoyment.
4. The system is generally fully digital but can be analog.
5. Each display is a stand alone system that requires no outside data source or troublesome network connections.

Various embodiments of the invention have now been described in detail. Since changes in and/or additions to the above-described best mode may be made without departing from the nature, spirit or scope of the invention, the invention is not to be limited to said details.

1. A system for locating an object including a three dimensional display.
